(19) United States
(12) Patent Application Publication
(10) Pub. No.: US 2026/0195904 A1
(43) Pub. Date: Jul. 9, 2026

(54) DEVICE FOR LOCALIZING A VEHICLE AND METHOD FOR LOCALIZING A VEHICLE

(71) Applicant: Continental Autonomous Mobility Germany GmbH, Ingolstadt (DE)

(72) Inventors: Srividhya Kannan, Chennai (IN); Ramalingam Dharmalingam, Dharmapuri (IN); Sneha K Hegde, Karkala (IN); Stefan Heinrich, Achern (DE)

(73) Assignee: Continental Autonomous Mobility Germany GmbH, Ingolstadt (DE)

(21) Appl. No.: 19/132,925

(22) PCT Filed: Nov. 22, 2023
(86) PCT No.: PCT/EP2023/082629

§ 371 Date: May 27, 2025

(30) Foreign Application Priority Data
Nov. 24, 2022 (GB) 2217544.2

(51) Int. Cl. G06T 7/246; G06T 7/285; G06T 7/593; G06T 7/73; G06V 10/40; G06V 10/82; G06V 20/56

(52) U.S. Cl. CPC G06T 7/246; G06T 7/285; G06T 7/593; G06T 7/73; G06V 10/40; G06V 10/82; G06V 20/56; G06T 2207/10021; G06T 2207/20028; G06T 2207/20081; G06T 2207/20084; G06T 2207/30244; G06T 2207/30252

(57) ABSTRACT

A device for localizing a vehicle may include a machine learning model and a localizer. The machine learning model may be configured to receive a sequence of image sets. Each image set of the sequence of image sets may include at least a first image and a second image. The machine learning model may be configured to determine a respective depth map for each image set based on at least the first image and the second image of the image set, resulting in a sequence of depth maps. The machine learning model may be further configured to determine an optical flow based on at least one of, the first images from the sequence of image sets and the second images from the sequence of image sets. The localizer may be configured to localize the vehicle based on the sequence of depth maps and the optical flow.

### CROSS-REFERENCE TO RELATED APPLICATIONS

The present application is a National Stage Application under 35 U.S.C. § 371 of International Patent Application No. PCT/EP2023/082629 filed on Nov. 22, 2023, and claims priority from Great Britain Patent Application No. 2217544.2 filed on Nov. 24, 2022, in the United Kingdom Intellectual Property Office, the disclosures of which are herein incorporated by reference in their entireties

### TECHNICAL FIELD

Various embodiments relate to devices for localizing a vehicle, and methods for localizing a vehicle.

BACKGROUND Over the past decade, due to the increasingly prominent performance of visual sensors in terms of image richness, price and data volume, vision-based odometry, in particular, simultaneous localization and mapping (SLAM) has gained more attention in the field of unmanned driving. Widely recognized SLAM techniques include parallel tracking and mapping (PTAM), large-scale direct monocular (LSD)-SLAM and direct sparse odometry (DSO) function. These existing SLAM techniques, in general, can only perform well in indoor environments or urban environments with obvious structural features. Their performance decreases over time in environments with complicated topographical features, such as off-road environments where environmental elements may be in a weak state of motion. For example, there may be vegetation that moves with the wind, drifting clouds, and changing textures of sandy roads due to passage of cars. Consequently, these off-road environments may lack stable trackable points for the existing SLAM techniques. In addition, factors such as direct sunlight, vegetation occlusion, rough roads and sensor failure may further complicate the difficulty of tracking objects in the environment.

In view of the above, there is a need for an improved method of localizing vehicles, that can address at least some of the abovementioned problems.

### SUMMARY

According to various embodiments, there is provided a device for localizing a vehicle. The device may include a machine learning model and a localizer. The machine learning model may be configured to receive a sequence of image sets. Each image set of the sequence of image sets may include at least a first image and a second image. The machine learning model may be configured to determine a respective depth map for each image set based on at least the first image and the second image of the image set, resulting in a sequence of depth maps. The machine learning model may be further configured to determine an optical flow based on at least one of, the first images from the sequence of image sets and the second images from the sequence of image sets. The localizer may be configured to localize the vehicle based on the sequence of depth maps and the optical flow.

According to various embodiments, there is provided a computer-implemented method for localizing a vehicle. The method may include inputting a sequence of image sets to a machine learning model. Each image set of the sequence of image sets may include at least a first image and a second image. The method may further include determining by the machine learning model, for each image set, a respective depth map based on at least the first image and the second image of the image set, resulting in a sequence of depth maps. The method may further include determining by the machine learning model, an optical flow based on at least one of, the first images from the sequence of image sets and the second images of the sequence of image sets. The method may further include localizing the vehicle based on the sequence of depth maps and the optical flow.

Additional features for advantageous embodiments are provided in the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments are described with reference to the following drawings, in which:

FIG. 1A shows a simplified functional block diagram of a device for localizing a vehicle according to various embodiments.

FIG. 1B shows a simplified hardware block diagram of the device of FIG. 1A according to various embodiments.

FIG. 2 illustrates an operation of the device of FIGS. 1A and 1B through a block diagram according to various embodiments.

FIGS. 3A and 3B show block diagrams of an embodiment of a machine learning model of the device of FIGS. 1A and 1B, carrying out operations, according to various embodiments.

FIG. 4 shows a block diagram of a pose estimator of the device of FIGS. 1A and 1B, according to various embodiments.

FIG. 5 shows examples of input to the device of FIGS. 1A and 1B.

FIG. 6 shows examples of output of the device of FIGS. 1A and 1B.

FIG. 7 shows a flow diagram of a method of localizing a vehicle, according to various embodiments.

FIG. 8 shows a simplified block diagram of a vehicle according to various embodiments.

FIG. 9 shows an example of how a position of a feature point may differ in the left image and the right image of a stereo image pair.

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the present disclosure may be readily understood and put into practical effect, various embodiments will now be described by way of examples and not limitations, and with reference to the figures.

According to various embodiments, a method for localizing a vehicle may be provided. The method may include multi-camera collaboration, to utilize the characteristics of panoramic vision and stereo perception to improve the localization precision in off-road environments. The method may be an improved Simultaneous Localization and Mapping (SLAM) technique, that solves the problem of incrementally constructing a consistent map of environment and localizing the vehicle in an unknown environment. The method may have the ability to use uncalibrated or unrectified stereo cameras for three-dimensional (3D) environment-reconstruction and localization of a vehicle. The method may allow estimation of scale from the uncalibrated/unrectified 3D reconstruction. As the method does not require the cameras to be calibrated, loosely-coupled satellite-stereo cameras may be used to capture images for the SLAM. The cameras may be coupled to the vehicle using non-rigid mounting structures. The method may be capable to accurate localization and mapping in spite of vibration and thermal effects experienced by the cameras. The map generated by the method may be of higher image quality due to reduced noise, such that small obstacles may be more effectively detected and identified in the map. The higher quality map and fast localization may also enable early detection of sudden traffic participants and change of navigation route.

According to various embodiments, the method may further include detection of two-dimensional (2D) or 3D objects in the generated map.

According to various embodiments, the method may further include tracking of 2D or 3D objects in the generated map.

According to various embodiments, the method may further include reconstruction of 3D scenes.

According to various embodiments, the method may further include 3D mapping and real-time detection of changes made to the environment.

According to various embodiments, the method may further include generation of 3D environmental model, in combination with other sensors such as radar or laser sensors.

According to various embodiments, the method may be used to at least one of detect lost cargo, detect objects, perform 3D road surface modelling, and perform augmented reality-based visualization.

According to various embodiments, a device 100 may be configured to perform any one of the abovementioned methods.

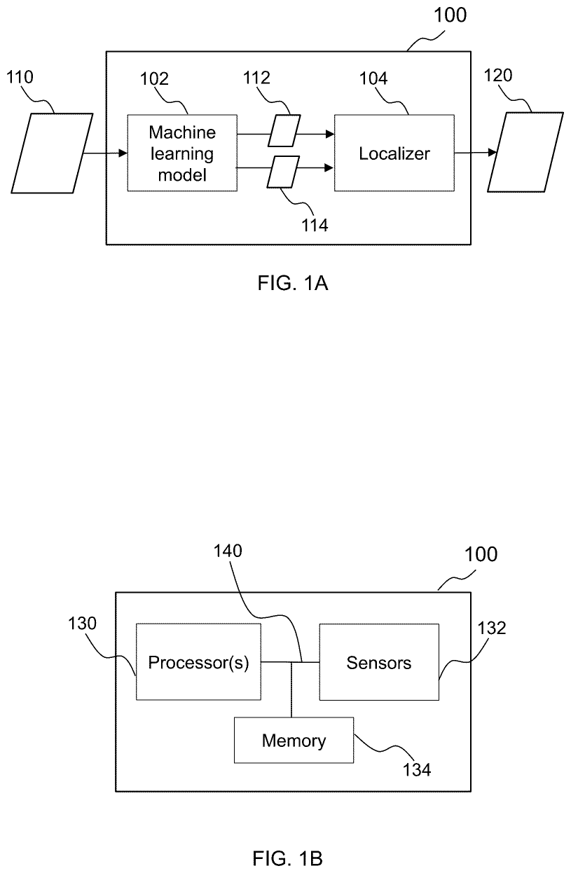

FIG. 1A shows a simplified functional block diagram of the device 100 for localizing a vehicle according to various embodiments. The device 100 may be configured to receive an input 110 and may be configured to generate an output 120. The input may include a sequence of image sets. The output 120 may include location of the vehicle, and may further include a trajectory of the vehicle. The device 100 may be capable of localizing the vehicle based on images.

The sequence of image sets in the input 110 may be captured by sensors mounted on the vehicle. Each image set may include a plurality of images, and each image of the plurality of images may be captured from a different position on the vehicle, such that the plurality of images of each image set may have an offset in at least one axis, from one another. The plurality of images may be respectively captured by a corresponding plurality of sensors.

The device 100 may include a machine learning model 102. The machine learning model 102 may configured to determine depth information of each image set, based on the plurality of images in the image set. The machine learning model 102 may output a sequence of depth maps 112 based on the received sequence of image sets. Each depth map may be an image or image channel that contains information relating to the distance of the surfaces of objects from a viewpoint. The viewpoint may be a vehicle, or more specifically, a sensor mounted on the vehicle. The machine learning model 102 may also be configured to determine an optical flow 114 based on the received sequence of image sets. The machine learning model 102 may determine a plurality of optical flows 114, wherein the number of optical flows may correspond to the plurality of images in each image set.

The device 100 may include a localizer 104. The localizer 104 may be configured to receive the sequence of depth maps 112 and the optical flows 114 from the machine learning model 102. The localizer 104 may be configured to generate the output 120 based on the received sequence of depth maps 112 and the optical flows 114.

In other words, the device 100 may include a machine learning model 102 and a localizer 104. The machine learning model 102 may be configured to receive a sequence of image sets. Each image set of the sequence of image sets may include at least a first image and a second image. The machine learning model 102 may be further configured to determine a respective depth map 112 for each image set based on at least the first image and the second image of the image set, resulting in a sequence of depth maps 112. The machine learning model 102 may be further configured to determine an optical flow 114 based on at least one of, the first images from the sequence of image sets and the second images from the sequence of image sets. The localizer 104 may be configured to localize the vehicle based on the sequence of depth maps 112 and the optical flow 114.

By using the depth information in combination with the optical flow to determine the vehicle location, the device 100 may overcome the challenges in referencing the vehicle location to a dynamic scene that includes moving objects. Consequently, the device 100 may achieve improved localization accuracy.

FIG. 1B shows a simplified hardware block diagram of the device 100 according to various embodiments. The device 100 may include at least one processor 130. The device 100 may further include a plurality of sensors 132. The at least one processor 130 may be configured to carry out the functions of the machine learning model 102 and the localizer 104. The device 100 may include at least one memory 134 may store the machine learning model 102 and the localizer 104. The at least one memory 134 may include a non-transitory computer-readable medium. The at least one processor 130, the plurality of sensors 132 and the at least one memory 134 may be coupled to one another, for example, mechanically or electrically, via the coupling line 140.

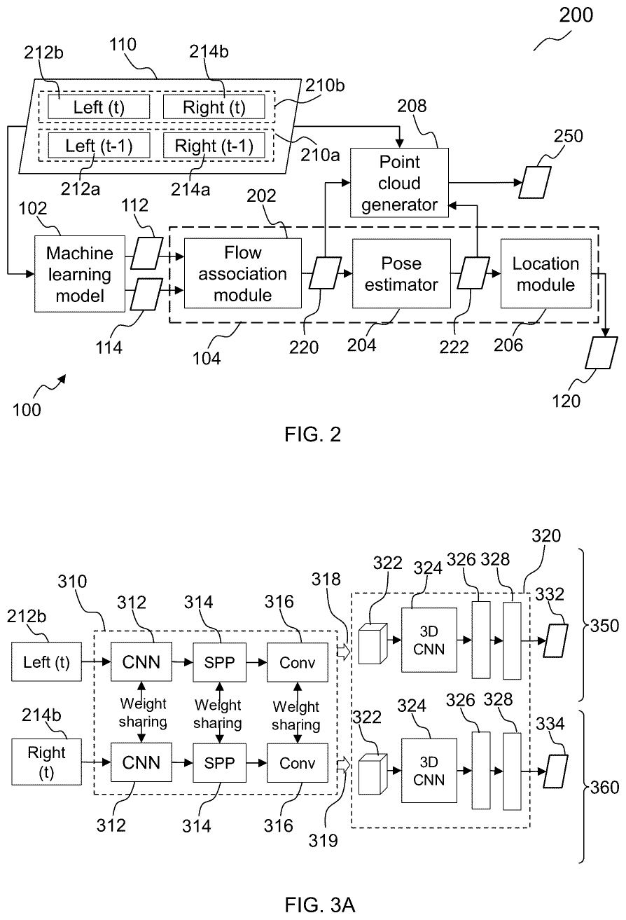

According to an embodiment which may be combined with any of the above-described embodiment or with any below described further embodiment, the localizer 104 may include a flow association module 202, a pose estimator 204 and a location module 206, which are described further with respect to FIG. 2. The flow association module 202 may be configured to generate a three-dimensional (3D) optical flow based on the sequence of depth maps 112 and the optical flow 114 determined by the machine learning model 102. The pose estimator 204 may be configured to determine the motion parameters of the vehicle based on the 3D optical flow. The location module 206 may be configured to localize the vehicle based on the determined motion parameters. By combining the sequence of depth maps and the optical flow, the device 100 may generate a dense 3D optical flow that provides detailed information for accurate determination of the vehicle motion parameters.

According to an embodiment which may be combined with any above-described embodiment or with any below described further embodiment, the device 100 may further include a point cloud generator 208 which is described further with respect to FIG. 2. The cloud generator may be configured to generate a 3D point cloud 250 based on the three-dimensional optical flow. The generated 3D point cloud 250 may be a 3D reconstruction of the environment the vehicle is travelling in. As the 3D point cloud 250 may be generated in real-time, the device 100 may provide the vehicle with environmental data that is not previously available, for example, previously unmapped terrain. Further, the 3D point cloud 250 may indicate to the vehicle, the presence of dynamic objects such as traffic participants.

According to an embodiment which may be combined with any above-described embodiment or with any below described further embodiment, the point cloud generator 208 may be further configured to update the generated 3D point cloud 250 based on the determined motion parameters. This may allow the vehicle to continuously have information on its surroundings, so that it may avoid obstacles. Also, the vehicle may be able to gather environmental information over an area by performing a trajectory within the area, for example, to perform a surveillance or exploration mission.

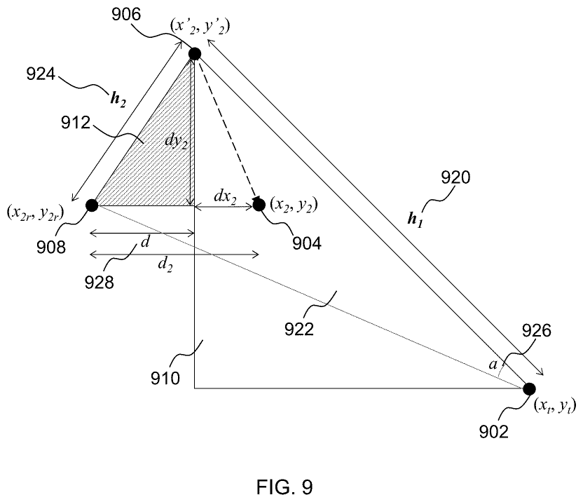

According to an embodiment which may be combined with any above-described embodiment or with any below described further embodiment, the device 100 may be further configured to determine unrotated disparities of each image set. The method of determining the unrotated disparities is described with respect to FIG. 9.

According to an embodiment which may be combined with any above-described embodiment or with any below described further embodiment, pose of the camera that captures the sequence of image sets, may be determined for every image frame, based on the optical flow 114 and the sequence of depth maps 112. The 3D point cloud 250 may be updated based on the determined pose of the camera. The pose of the camera may be determined based on the motion parameters.

According to an embodiment which may be combined with any above-described embodiment or with any below described further embodiment, the flow association module 202 may be configured to generate the 3D optical flow 220 by determining a depth flow of each pixel in the sequence of image sets, and concatenating the depth flows with the optical flow 114 determined by the machine learning model 102. The concatenated depth flow with optical flow 114 may provide a compact data structure to be processed by the pose estimator 204. This may provide an efficient, i.e. computationally simple, approach to generate dense 3D optical flow.

According to an embodiment which may be combined with any above-described embodiment or with any below described further embodiment, the flow association module 202 may be further configured to interpolate missing flow pixels between two adjacent image sets, through bilinear filtering. Interpolating the missing flow pixels may include mapping a pixel location to a corresponding point on a text map, taking a weighted average of the attributes, such as color and transparency, of the four surrounding texels (i.e., texture elements) and applying the weighted average to the pixel. This may avoid gaps in the resulting 3D optical flow 220, and thereby reconstruct a dense 3D point cloud 250.

According to an embodiment which may be combined with any above-described embodiment or with any below described further embodiment, the pose estimator 204 may include two branches of convolution stacks 420, a concatenating layer 404 connected to the two branches of convolution stacks, and two regressor stacks 408 connected to the concatenating layer 404. The pose estimator 204 is described further with respect to FIG. 4. The convolution stacks 420 may extract features from the 3D optical flow 220. A first branch of the convolution stacks 420 may extract feature information from the depth flow, i.e. along Z-direction. A second branch of the convolution stacks 420 may extract feature information from 2D flow, i.e. along X and Y directions. The concatenating layer 404 may combine the extracted features for feeding into the two regressors stacks 408. The regressor stacks 408 may then determine the motion parameters based on the extracted features.

According to an embodiment which may be combined with any above-described embodiment or with any below described further embodiment, the pose estimator 204 may further includes a squeeze layer 406 connected between the concatenating layer 404 and the two regressor stacks 408. The squeeze layer 406 may be configured to compress the output of the concatenating layer 404 into a lower dimensional space, such that the regressor stacks 408 may require lesser computational resources in determining the motion parameters.

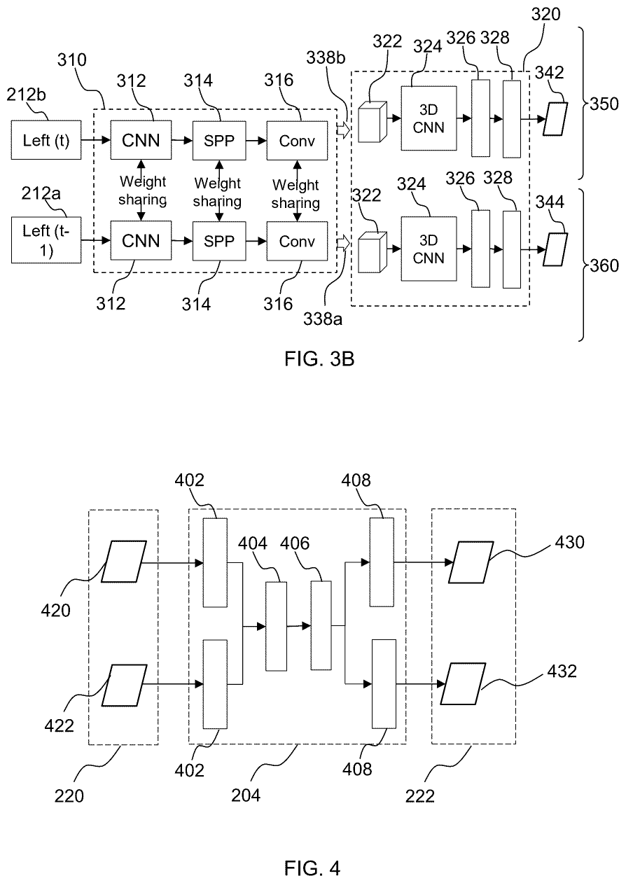

According to an embodiment which may be combined with any above-described embodiment or with any below described further embodiment, the machine learning model 102 may include a feature extraction network 310 and a disparity computation network 320, which are described further with respect to FIGS. 3A and 3B. The feature extraction network 310 may be configured to extract features from images in the sequence of image sets to generate feature maps. The disparity computation network 320 may be configured to determine two-dimensional offsets (also referred herein as displacements) between the images based on the generated feature maps. The machine learning model 102 may thereby determine both optical flow and depth information using a single common set of neural networks, as both the optical flow and depth information relate to two-dimensional offsets between images. As such, the device 100 may be computationally efficient, and its machine learning model 102 may be trained in a shorter time and with less resources, as compared to training two separate machine learning models.

According to an embodiment which may be combined with any above-described embodiment or with any below described further embodiment, the machine learning model 102 may be trained via supervised training, using scene flow stereo images. Training the machine learning model 102 may require, for example, 25,000 scene flow stereo images as the training data. The machine learning model 102 may be fine-tuned using stereo images. As an example, about 400 stereo images may be used for the training. As an example, the stereo images may be obtained from a public training dataset such as the KITTI dataset, the Cityscapes, and the likes. The stereo images may also be synthetically generated based on ground truth images.

According to an embodiment which may be combined with any above-described embodiment or with any below described further embodiment, training of the machine learning model 102 may, for example, be based on standard backpropagation based gradient descent. As an example how the machine learning model 102 may be trained, a training dataset may be provided to the machine learning model 102, and the following training processes may be carried out:

Before training the machine learning model 102, the weights may be randomly initialized to numbers between 0.01 and 0.1, while the biases may be randomly initialized to numbers between 0.1 and 0.9.

Subsequently, the first observations of the dataset may be loaded into the input layer of the neural network in the machine learning model 102 and the output value(s) is generated by forward-propagation of the input values of the input layers. Afterwards the following loss function may be used to calculate loss with the output value(s):

### Mean Square Error (MSE):

$$MSE = \frac{1}{n} \sum {( y - \hat{y} )}^{2} ,$$

where n represents the number of neurons in the output layer and y represents the real output value and ŷ represents the predicted output. In other words, y-ŷ represents the difference between actual and predicted output.

The weights and biases may subsequently be updated by an Adam Optimizer with a learning rate of 0.001. Other parameters of the Adam Optimizer may be set to default values. For example:

$$beta\_ 1 = 0.9$$

$$beta\_ 2 = 0.9 \; 99$$

$$eps = 1 e - 08$$

$$weight\_decay = 0$$

The steps described above may be repeated with the next set of observations until all the observations are used for training. This may represent the first training epoch, and may be repeated until 10 epochs are done.

According to an embodiment which may be combined with any above-described embodiment or with any below described further embodiment, the feature extraction network 310 may include a plurality of neural network branches. For example, the neural network branches may include a first branch 350 and a second branch 360 shown in FIGS. 3A and 3B. Each neural network branch may include a respective convolutional stack, and a pooling module connected to the convolutional stack. The convolutional stack may include, for example, the CNN 312. The pooling module may include, for example, the SPP module 314. The plurality of neural network branches may share the same weights. By having the neural network branches share the same weights, the feature extraction network 310 may be trained in a shorter time and with less resources, than training the neural network branches individually.

According to an embodiment which may be combined with any above-described embodiment or with any below described further embodiment, the disparity computation network 320 may include a 3D convolutional neural network (CNN) 324 configured to generate three disparity maps based on the generated feature maps 318. The feature extraction network 310 may extract features at different levels. To aggregate the feature information along disparity dimension as well as spatial dimensions, the 3D CNN 324 may be configured to perform cost volume regularization on the extracted features. The 3D CNN 324 may include an encoder-decoder architecture including a plurality of 3D convolution and 3D deconvolution layers with intermediate supervision. The 3D CNN 324 may have a stacked hourglass architecture including three hourglasses, thereby producing three disparity outputs. The architecture of the 3D CNN 324 may enable it to generate accurate disparity outputs and to predict the optical flow. The filter size in the 3D CNN 324 may be 3*3.

According to an embodiment which may be combined with any above-described embodiment or with any below described further embodiment, the machine learning model 102 may be configured to determine the respective depth map 112 of each image set based on the determined 2D offsets between the plurality of images of the image set. The depth map 112 may provide information on distance between objects in the images from the vehicle. This information may improve the localization accuracy. Each pixel in the depth map may be determined based on the following equation:

$$Depth = \frac{baseline \times focal length}{disparity}$$

Where baseline refers to the horizontal distance between the viewpoints that the images within the same image set were captured, focal length refers to the distance between the lens and the camera sensor, and disparity refers to the 2D offsets.

According to an embodiment which may be combined with any above-described embodiment or with any below described further embodiment, the machine learning model 102 may be configured to determine the optical flow 112, based on the determined 2D offsets between at least one of, the first images of adjacent image sets of and the second images of adjacent image sets. The optical flow 112 may provide information on the changes in position of the vehicle.

According to an embodiment which may be combined with any above-described embodiment or with any below described further embodiment, the device 100 may further include a plurality of sensors 132 mountable on a vehicle. The plurality of sensors 132 may be adapted to capture the sequence of image sets. The plurality of sensors 132 may include, for example, a set of surround view cameras. The plurality of sensors 132 may provide redundancy, so that the device 100 may continue to receive multiple images when one sensor fails.

According to an embodiment which may be combined with any above-described embodiment or with any below described further embodiment, the plurality of sensors 132 may include a stereo camera. Each image set may include a pair of stereo images. Stereo cameras include two individual, but closely located sensors such that the captured stereo images may provide depth information.

According to an embodiment which may be combined with any above-described embodiment or with any below described further embodiment, each first image is captured from a first position on a vehicle, and each second image is captured from a second position on the vehicle. The second position may be different from the first position. The images are captured from different viewpoints, so that the images when combined, may provide depth information.

FIG. 2 illustrates an operation of the device 100 according to various embodiments. The input 110 to the device 100 may include a sequence of image sets. The sequence of image sets may include consecutively captured images. For example, the sequence of image sets may include an image set 210a captured at t−1, and another image set 210b captured at t, where t denotes time as a variable. In other words, the image set 210b may be a subsequent frame to the image set 210a. Each image set may include a plurality of images, each captured at a respective position. These positions may be offset from one another, such that a combination of the plurality of images may provide depth information of the objects shown in the images. For example, each of the image set 210a and the image set 210b may include a pair of stereo images. The image set 210a may include a left image 212a and a right image 214a. The image set 210b may include a left image 212b and a right image 214b.

The sequence of image sets 210a, 210b may be provided to the machine learning model 102. The machine learning model 102 may be trained to perform dual functions of computing depth maps 112, and computing optical flow 114, for at least two consecutive image sets. The machine learning model 102 may be trained to perform both functions using a common set of neural networks, and using the same set of weights in the set of neural networks. The machine learning model 102 may be trained to identify features in images and further configured to determine spatial offset, also referred herein as disparity data, of the features between the images. The spatial offset between images of the same image set may provide depth information of the features. The spatial offset between images captured at the same position across the sequence of image sets, i.e. over time, may provide information on the optical flow. Correspondingly, the common set of neural networks may achieve dual function of determining depth maps 112 and optical flow 114.

The localizer 104 may receive the depth maps 112 and the optical flow 114 from the machine learning model 102. The localizer 104 may include a flow association module 202, a pose estimator 204 and a location module 206. The optical flow 114 may include information of movement in two dimensions, i.e. may include two-dimensional (2D). The optical flow 114 may include dense 2D optical flow. The flow association module 202 may generate dense 3D optical flow 220 based on the optical flow 114 and the corresponding depth maps 112.

The flow association module 202 may determine a depth flow, in other words, the optical flow along the depth axis (also referred herein as the Z-axis), based on the sequence of depth maps 112 and the optical flow 114 provided by the machine learning model 102. The flow association module 202 may determine the depth flow according to equation (1), as follows:

$${H}_{z}^{k : k + 1} ( x , y ) = {G}^{k + 1} ( ( x , y ) + {H}_{X Y}^{k : k + 1} ( x , y ) ) - {G}^{k} ( x , y ) . \qquad ( 1 )$$

In the above equation (1),

$${H}_{z}^{k : k + 1} ( x , y )$$

represents the depth flow between frames k and k+1, at pixel coordinate (x,y).

$${H}_{X Y}^{k : k + 1} ∈ {s}^{h \times w \times 2}$$

represents the optical flow 114 on an X-Y image plane between frames k and k+1, and G^{k}∈s^{h×w} represents the depth map 112 of frame k, where s represents the X-Y image plane, h represents the height of the image and w represents the width of the image.

The flow association module 202 may generate the 3D optical flow 220 at each pixel coordinate by concatenating the 2D optical flow 114 and the depth flow. The 3D flow 220 may be determined according to equation (2), as follows:

$${H}_{3 D}^{k : k + 1} = C ( {H}_{X Y}^{k : k + 1} , {H}_{Z}^{k : k + 1} ) . \qquad ( 2 )$$

In the above equation (2),

$${H}_{3 D}^{k : k + 1} ∈ {s}^{3}$$

represents the 3D flow at pixel coordinate (x,y), and C denotes the concatenation operation.

If the depth value in frame k+1 cannot be associated with the corresponding depth value in frame k, the flow association module 202 may interpolate the missing flow pixels between two adjacent frames through bilinear filtering. The inverse depth (i.e., disparity) may be more sensitive to the motion of surroundings and objects close to the camera. Hence, the inverse depth is used instead of the depth value. The difference between the coordinates of left image and right image of the corresponding pixels is known as stereo correspondence or disparity, which is inversely proportional to the distance of the object from the camera. As such, disparity may also be referred as the inverse depth. The 3D optical flow 220 may be represented as 3D-motion-vectors.

The pose estimator 204 may receive the 3D optical flow 220 that is output by the flow association module 104. The pose estimator 204 may determine motion parameters 222 based on the 3D optical flow 220. The motion parameters 222 may include 6 degrees of freedom (6DOF) relative pose, including scale, transform between each pair of images. The location module 206 may determine the trajectory of the vehicle by accumulating the relative poses over time. The location module 206 may also localize the vehicle based on the accumulated relative poses. The output 120 of the location module may include at least one of the vehicle trajectory and the vehicle location.

According to various embodiments, the pose estimator 204 may include a neural network architecture that is described further with respect to FIG. 4.

Still referring to FIG. 2, the device 100 may further include a point cloud generator 208. The point cloud generator 208 may generate a 3D point cloud 250 based on the 3D optical flow 220 and the image sets 210a, 210b in the input 110. The 3D point cloud 250 may be generated based on depth map and camera intrinsic parameters such as focal length along x,y camera principal point offset and axis skew. The point cloud generator 208 may further update the 3D point cloud 250 based on the motion parameters 222. The point cloud generator 208 may also refine the 3D point cloud 250 to remove outliers and incorrect predictions, so that the 3D point cloud 250 may serve as an accurate dense 3D map. The point cloud generator 208 may remove the outliers and incorrect predictions based on probability of those data points.

The device 100 may simultaneously generate the 3D point cloud 250 and the output 120. The device 100 may further combine the output 120 with the 3D point cloud 250, to present the vehicle movements in the 3D point cloud 250. By generating both the 3D point cloud 250 and the vehicle location concurrently, the device 100 may provide the function of Simultaneous Localization and Mapping (SLAM).

FIGS. 3A and 3B show block diagrams of an embodiment of the machine learning model 102, carrying out operations, according to various embodiments. Referring to FIG. 3A, the machine learning model 102 may be performing a stereo matching operation. The stereo matching operation may include determining estimate a pixelwise displacement map between the input images. The input images may include a plurality of images of the same image set. For example, when the input 110 contains images captured by a stereo camera, the input images may include a left image 212b and a right image 214b.

In general, stereo images may be rectified stereo images or unrectified stereo images. Rectified stereo images are stereo images where the displacement of each pixel is constrained to a horizontal line. The displacement map may be referred herein as disparity. To obtain rectified stereo images, the sensors or cameras used to capture the images need to be accurately calibrated.

Unrectified stereo images, on the other hand, may exhibit both vertical and horizontal disparity. Vertical disparity may be defined as the vertical displacement between corresponding pixels in the left and right images. Horizontal disparity may be defined as the horizontal displacement between corresponding pixels in the left and right images. It is challenging to obtain rectified stereo images from sensors mounted on a vehicle, as the sensors may shift or rotate in position over time, due to movement and vibrations of the vehicle. As such, the input images captured by the sensors mounted on the vehicle may be regarded as unrectified stereo images.

The machine learning model 102 may be trained to be robust against rotation, shift, vibration and distortion of the input images. The machine learning model 102 may be trained to handle both horizontal (x-disparity) and vertical (y-disparity) displacement. In other words, the machine learning model 102 may be configured to determine both the horizontal and vertical disparity of the input images. This makes the machine learning model 102 robust against vertical translation and rotation between cameras or sensors.

The machine learning model 102 may have a dual-branch neural network architecture including a first branch 350 and a second branch 360, such that each branch may be configured to determine disparity in a respective axis. The machine learning model 102 may include a feature extraction network 310 and a disparity computation network 320. Each of the feature extract network 310 and the disparity computation network 320 may include components of the first branch 350 and the second branch 360.

The feature extraction network 310 may include a convolutional neural network (CNN) 312, a spatial pyramid pooling (SPP) module 314 and a convolution layer 316, for each of the first branch 350 and the second branch 360. The CNN 312 may extract feature information from the input images. The CNN 312 may include three small convolution filters with kernel size (3×3) that are cascaded to construct a deeper network with the same receptive field. The CNN 312 may include conv1_x, conv2_x, conv3_x, and conv4_x layers that form the basic residual blocks for learning the unitary feature extraction. For conv3_x and conv4_x, dilated convolution may be applied to further enlarge the receptive field. The output feature map size may be (¼× ¼) of the input image size. The SPP module 314 may be then applied to gather context information from the output feature map. The SPP module 314 may learn the relationship between objects and its sub regions to incorporate hierarchical context information. The SPP module 314 may include four fixed-size average pooling blocks of size 64×64, 32×32, 16×16, and 8×8. The convolution layer 316 may be a 1×1 convolution layer for reducing feature dimension. The feature extraction network 310 may up-sample the feature maps to the same size as the original feature map, using bilinear interpolation. The size of the original feature map may be ¼ of the input image size. The feature extraction network 310 may concatenate the different levels of feature maps extracted by the various convolutional filters, as the left SPP feature map 318 and the right SPP feature map 319.

The disparity computation network 320 may receive the left SPP feature map 318 and the right SPP feature map 319. The disparity computation network 320 may concatenate the left and right SPP feature maps 318, 319 into separate cost volumes 322 for x and y displacements respectively. Each cost volume may have 4 dimensions, namely, height× width× disparity× feature size. The disparity computation network 320 may include a 3D-CNN 322 in each branch. The 3D-CNN 322 may include a stack hourglass (encoder-decoder) architecture that is configured to generate three disparity maps. The disparity computation network 320 may further include an upsampling module 326 and a regression module 328, in each branch. The upsampling module 326 may upsample the three disparity maps so that their resolution matches that of the input image size. The regression module 328 may apply regression to the upsampled disparity maps, to calculate an output disparity map. The disparity computation network 320 may calculate the probability of each disparity based on the predicted cost via SoftMax operation. The predicted disparity may be calculated as the sum of each disparity weighted by its probability. Next, smooth loss function may be applied between ground truth disparity and predicted disparity. The smooth loss function may measure how close the predictions are, to the ground truth disparity values. The smooth loss function may be a combination of l1 and l2 loss. It is used in deep neural network because of its robustness and low sensitivity to outliers. The disparity computation network 320 then outputs the horizontal displacement 332 at the first branch 350, and outputs the vertical displacement 334 at the second branch 360. The machine learning model 102 may then determine a depth map 112 based on the horizontal displacement 332 and the vertical displacement 334, using known stereo computation methods such as semi global matching.

Referring to FIG. 3B, the machine learning model 102 may be performing an optical flow computation operation. The optical flow computation operation may include predicting a pixelwise displacement field, such that for every pixel in a frame, the machine learning model 102 may estimate its corresponding pixel in the next frame. For the optical flow computation operation, the input images used by the machine learning model 102 may be two successive images taken from the same position. In this example, the input images are left image 212b captured at time=t and left image 212a captured at time=t−1. The outputs of the machine learning model 102 for the optical flow computation operation is the optical flow 114 that includes x-direction displacement 342 and γ-direction displacement 344.

The first branch 350 may process the left image 212b, while the second branch 360 may process the earlier left image 212a. Similar to the stereo-matching operation described with respect to FIG. 3A, the optical flow computation operation may include extracting features using the CNN 312 of the feature extraction network 310. The SPP module 314 may gather context information from the output feature map generated by the CNN 312. The feature extraction network 310 generate final SPP feature maps 318 that are provided to the disparity computation network 320. The difference from the stereo-matching operation, is that the SPP feature maps generated are an earlier SPP feature map 338a (for time=t−1) and a subsequent SPP feature map 338b (for time=t). The disparity computation network 320 may concatenate the SPP feature maps 338a, 338b into separate cost volumes 322 for time=t−1 and time=t respectively. Each cost volume may have 4 dimensions, namely, height× width× disparity× feature size. The 3D-CNN 322 of each branch may generate three disparity maps based on the respective cost volume 322. The upsampling module 326 may upsample the three disparity maps. The regression module 328 may apply regression to the upsampled disparity maps, to calculate an output disparity map. The disparity computation network 320 may calculate the probability of each disparity based on the predicted cost via SoftMax operation. The predicted disparity may be calculated as the sum of each disparity weighted by its probability. Next, smooth loss function may be applied between ground truth disparity and predicted disparity. The disparity computation network 320 then outputs the x-direction displacement 342 and the y-direction displacement 344, that are determined to take place between time=t−1 to time=t.

According to various embodiments, suitable deep learning models for the machine learning model 102 may include, for example, Pyramid Stereo Matching and RAFTNet.

FIG. 4 shows a block diagram of the pose estimator 204 according to various embodiments. The pose estimator 204 may include a dual stream architecture network, composed of two branches of convolution stacks 402 followed by a concatenation layer 404, a squeeze layer 406 and two fully connected regressor stacks 408. The pose estimator 204 may receive the 3D optical flow 220 as an input. The 3D optical flow 220 may include a first data portion 420 that may include 2D optical flow, and a second data portion 422 that may include depth flow. One branch of convolution stack 402 may receive 420, and the other branch of convolution stack 402 may receive 422.

The convolution stacks 402 may each include 4 layers composed of 3×3 filters and of stride 2. The numbers of channels in the two branches of convolution stacks 402 may be 64, 128, 256 and 512. In order to keep the spatial geometry information, the pooling layer is abandoned in these two CNN stacks, and instead, an attention layer may be added to obtain the features present in the images. The feature maps extracted by the two branches may be concatenated by the concatenating layer 404 and squeezed using a 1×1 filter of the squeeze layer 406. The squeeze layer 406 may embed the 3D feature map into a lower dimensional space, thereby reducing the input dimension of the regressor stacks 408. Each regressor stack 408 may include a triple-layer fully connected network. The hidden layers of the regressor stack 408 may be set to size 128 with ReLu activation function. One regressor stack 408 (herein referred to as the translation regressor) may output the translation 430 determined from the 3D optical flow 220. Another regressor stack 408 (herein referred to as the rotation regressor) may output the rotation 432 determined from the 3D optical flow 220. The output of the translation regressor may be 6 for bivariate Gaussian loss and that of the rotation regressor may be 3, which may be trained through a L2 loss. To find the correlation along the forward and left/right direction, the Bivariate Gaussian Probability Distribute Function may be used as the likelihood function. Once the pose estimator 204 is trained, the translation 430 and the rotation 432 may be estimated from the pose estimator 204. The translation 430 and the rotation 432 may be part of the motion parameters 220. The pose estimator 204 may be trained using sequences with ground truth, for example, 11 of such sequences with ground truth.

The pose estimator 204 may add a new frame to a frame graph, adding edges with its 3 closest neighbors as measured by the mean optical flow. The pose estimator 204 may initialize the pose using a linear motion model. The pose estimator 204 may then apply several iterations of the update operator to update keyframe poses and depths. The update operator may be configured to carry out the PnP method. The first two poses may be fixed, to remove gauge freedom but all depths may be treated as free variables. After the new frame is tracked, a keyframe may be selected for removal. The pose estimator may determine distance between pairs of frames by computing the average optical flow magnitude and by removing redundant frames. If no frame is a good candidate for removal, the oldest keyframe may be removed. The reprojection error may be computed after 10 frames to optimize the pose estimated between frames.

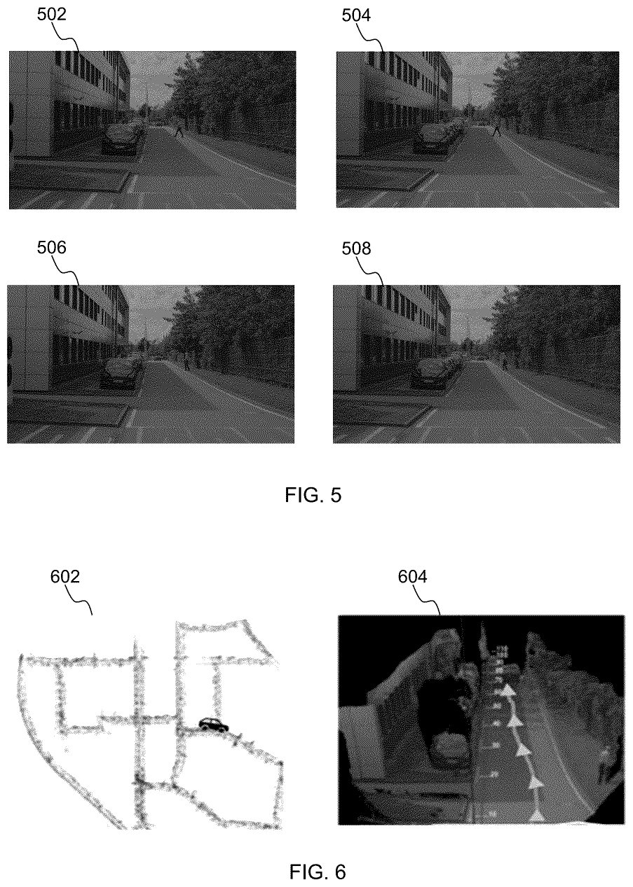

FIG. 5 shows examples of input 110 to the device 100. Image 502 may be a left stereo image captured at time=t, while image 504 may be a right stereo image captured at time=t−1. Image 506 may be a left stereo image captured at time=t, while image 508 may be a right stereo image captured at time=t−1. The image frame captured at time=t may be referred herein as the k″ image frame, while the image frame captured at time=t may be referred herein as the k FIG. 6 shows examples of output 120 of the device 100. Image 602 shows a trajectory of the vehicle, while image 604 shows a trajectory of the vehicle displayed within a 3D point cloud.

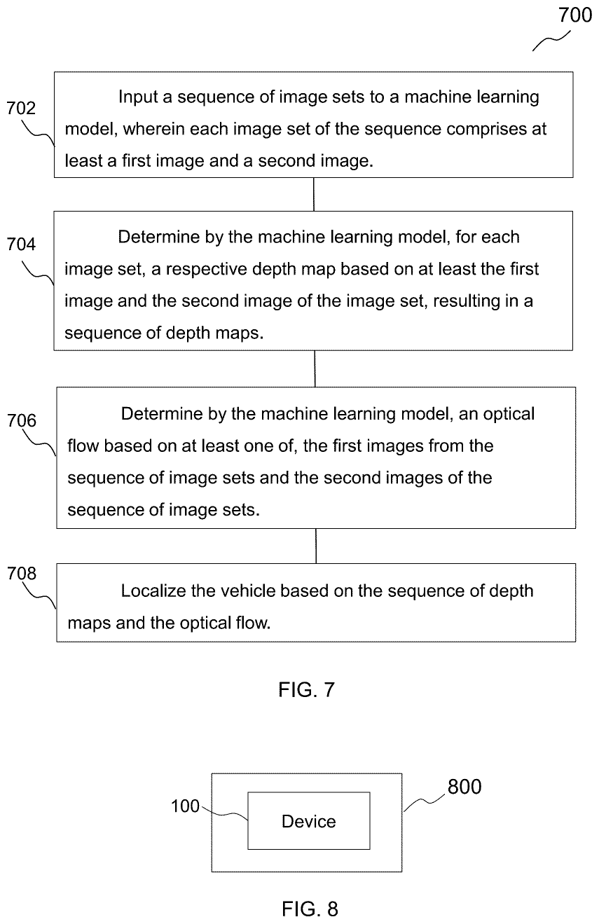

FIG. 7 shows a flow diagram of a method 700 of localizing a vehicle, according to various embodiments. The method 700 may include processes 702, 704, 706 and 708. The process 702 may include inputting a sequence of image sets to a machine learning model, wherein each image set of the sequence includes at least a first image and a second image. The sequence of image sets may include for example, the image sets 210a, 210b. The machine learning model may be for example, the machine learning model 102. The process 704 may include determining by the machine learning model, for each image set, a respective depth map based on at least the first image and the second image of the image set, resulting in a sequence of depth maps. In an example, the image set may include a pair of stereo images, where the first image may be, for example, the left image 212a or 212b while the second image may be, for example, the right image 210a or 210b. The depth maps may include, for example, the depth maps 112. The process 706 may include determining by the machine learning model, an optical flow based on at least one of, the first images from the sequence of image sets and the second images of the sequence of image sets. The optical flow may be for example, the optical flow 114. The process 708 may include localizing the vehicle based on the sequence of depth maps and the optical flow. Various aspects described with respect to the device 100 may be applicable to the method 700.

According to various embodiments, a non-transitory computer-readable medium may be provided. The computer-readable medium may include instructions which, when executed by a processor, cause the processor to carry out the method 700. Various aspects described with respect to the device 100 may be applicable to the computer-readable medium.

FIG. 8 shows a simplified block diagram of a vehicle 800 according to various embodiments. The vehicle 800 may include the device 100, according to any above-described embodiment or with any below described further embodiment. Various aspects described with respect to the device 100 and the method 700 may be applicable to the vehicle 800.

According to various embodiments, the method (700) for localizing a vehicle may further include determining unrotated disparities in each image set of the sequence of image sets. The depth maps 112 may be determined based on the determined unrotated disparities.

In a general stereo camera set up, a feature point of the left stereo image and the corresponding feature point of the right stereo image are aligned on the same x-axis, also referred to as horizontal axis. Due to vibration or mechanical set up, one of the stereo cameras may be misaligned with the other stereo camera with at least one of the following factors: roll, i.e. rotation angle (a), pitch, yaw, and translation (xₜ, yₜ) where xₜ refers to movement of an image pixel along the horizontal axis and yₜ refer to movement of the image pixel along the vertical axis. The machine learning model 102 may be configured to determine rotated disparities for the above-mentioned misalignments. The rotated disparity map may include the actual disparities of every pixel between the uncalibrated left and right stereo images.

The device 100 may further include a rotation correction module that corrects the rotated disparity map for the relative rotation between the images in the image set. The rotation correction module may generate a unrotated disparity map based on the rotated disparity map. The unrotated disparity map may include corrected disparities of every pixel between the uncalibrated left and right stereo images, as if the misaligned stereo image was already corrected back to its calibrated position.

FIG. 9 shows an example of how a position of a feature point may differ in a left image and a right image in an image set. In this example, an image center 902 may be considered to be (0,0). A feature point 904 of the left image is denoted as (x₂, y₂). The corresponding position 906 of the feature point 904 in the right image as rotated, is denoted as (x′₂, y′₂). A line connecting the corresponding position 906 and the image center 902 may define a first hypotenuse 920, indicated herein as “h₁”, of a right angle triangle 910. The corresponding position 906 of the feature point 904 in the right image may be determined based on the rotated disparity map.

The rotated disparity map may include rotated disparity values (dx₂, dy₂) for the feature point 904. The corresponding position 906, and the first hypothenuse 920, may be determined based on the feature point 904 and the rotated disparity values according to the following equations (1) to (3).

$${x}_{2}^{′} = {x}_{2} + d {x}_{2} \qquad Equation ( 1 )$$

$${y}_{2}^{′} = {y}_{2} + d {y}_{2} \qquad Equation ( 2 )$$

$${h}_{1} = \sqrt{( {x}_{2}^{′2} + {y}_{2}^{′2} )} \qquad Equation ( 3 )$$

The unrotated disparity values of the feature point 904 may be expressed as (dx₂, dy₂). The unrotated corresponding position 908 of the feature point 904 in the right image when the right image is adjusted to have zero rotation angle relative to the left image, is denoted as (x₂ᵣ, y₂ᵣ).

The corresponding position 906, the unrotated corresponding position 908 and the image center 902 may define vertices of an isosceles triangle 922. The distance between the corresponding position 906 and the image center 902 may be at least substantially equal to the distance between the unrotated corresponding position 908 and the image center 902, in other words, equal to the first hypotenuse 920. The vertex angle 926 of the isosceles triangle 922 is denoted as a. The vertex angle 926 may also be referred herein as rotation angle 926.

A line connecting the corresponding position 906 and the unrotated corresponding position 908, may define a second hypotenuse 924, denoted herein as “h₂”, of another right angle triangle 912. The second hypotenuse 924 may be the base of the isosceles triangle 922. The second hypotenuse 924 may be determined according to equation (4).

$${h}_{2} = 2 \times {h}_{1} \times sin \frac{a}{2} \qquad Equation ( 4 )$$

The base 928 of the other right angle triangle 412 is denoted as d. The length of the base 928 may be determined according to the equation (5).

$$d = {\sqrt{( {h}_{2}^{2} - d {y}_{2}^{2} )}}_{} . \qquad Equation ( 5 )$$

The unrotated disparity value d₂ may be determined based on the base 928 and the rotated disparity value dx₂. The unrotated disparity value may be determined according to the following equation (6).

$${d}_{2} = d + d {x}_{2} \qquad Equation ( 6 )$$

The rotation correction module may determine the unrotated disparity map based on the abovementioned computations. The rotation correction module may determine the corresponding position 906 based on the rotated disparity values in the rotated disparity map. The rotation correction module may determine the first hypothenuse 920 based on the corresponding position 906. The rotation correction module may determine the vertex angle 926. Determining the vertex angle 926 may include determining direction of epipolar lines of the image set, in the image plane without using 3D space. The vertex angle 926 may then be obtained by projecting the rotated disparity measurements towards the epipolar line directions. The rotation correction module may determine the second hypotenuse 924 based on the vertex angle 926 and the first hypotenuse 920. The rotation correction module may determine the base 928 based on the second hypotenuse 924 and the rotated disparity values. The rotation correction module 202 may determine the unrotated disparity value based on the base 928 and the rotated disparity values.

According to an embodiment which may be combined with any above-described embodiment or with any below described further embodiment, the rotation correction module may be configured to determine direction of epipolar lines of the image set, in the image plane without using 3D space. The rotation correction module may determine the epipolar line directions without prior knowledge about the intrinsic and extrinsic camera parameters. The rotation correction module may determine the epipolar line directions, by processing the images in the image set, region by region. In other words, the images may be segmented into a plurality of regions, and the epipolar line directions may be determined in each region of the plurality of regions.

The rotation correction module may be configured to check for infinity-negative disparities in the vertical disparity. The real distance represented in the images may be computed by the projection of the disparities through the epipolar line direction. The real distances may be determined region by region, in other words, determined in each region of the plurality of regions.

According to an embodiment which may be combined with any above-described embodiment or with any below described further embodiment, the rotation correction module may be further configured to determine the translation (xₜ, yₜ) and further configured to correct the right image with respect to the left image, based on the determined translation. The horizontal translation xₜ may be computed using tracking and filtering of the input images over time. The vertical translation yₜ may be determined based on the pixel information in the centre of y-disparity in a y-disparity array.

While embodiments of the present disclosure have been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1. A device for localizing a vehicle, the device comprising:
a machine learning model configured to receive a sequence of image sets, wherein each image set of the sequence of image sets comprises at least a first image and a second image;
wherein the machine learning model is further configured to determine a respective depth map for each image set based on at least the first image and the second image of the image set, resulting in a sequence of depth maps,
wherein the machine learning model is further configured to determine an optical flow based on at least one of, the first images from the sequence of image sets and the second images from the sequence of image sets; and
a localizer configured to localize the vehicle based on the sequence of depth maps and the optical flow.

2. The device of claim 1, wherein the localizer comprises
a flow association module configured to generate a three-dimensional optical flow based on the sequence of depth maps and the optical flow determined by the machine learning model, and
wherein the localizer further comprises a pose estimator configured to determine the motion parameters of the vehicle based on the three-dimensional optical flow, and
a location module configured to localize the vehicle based on the determined motion parameters.

3. The device of claim 2, further comprising:
a point cloud generator configured to generate a three-dimensional point cloud based on the three-dimensional optical flow.

4. The device of claim 3, wherein the point cloud generator is further configured to update the generated three-dimensional point cloud based on the determined motion parameters.

5. The device of claim 3, wherein the flow association module is configured to generate the three-dimensional optical flow by determining a depth flow of each pixel in the sequence of image sets and concatenating the depth flows with the optical flow determined by the machine learning model.

6. The device of claim 5, wherein the flow association module is further configured to interpolate missing flow pixels between two adjacent image sets, through bilinear filtering.

7. The device of claim 3, wherein the pose estimator comprises two branches of convolution stacks, a concatenating layer connected to the two branches of convolution stacks, and two regressor stacks connected to the concatenating layer.

8. The device of claim 7, wherein the pose estimator further comprises a squeeze layer connected between the concatenating layer and the two regressor stacks, wherein the squeeze layer is configured to compress the output of the concatenating layer into a lower dimensional space.

9. The device of claim 1, wherein the machine learning model comprises
a feature extraction network configured to extract features from images in the sequence of image sets to generate feature maps, and
wherein the machine learning model further comprises a disparity computation network configured to determine two-dimensional offsets between the images based on the generated feature maps.

10. The device of claim 9, wherein the feature extraction network comprises a plurality of neural network branches, wherein each neural network branch comprises a respective convolutional stack, and a pooling module connected to the convolutional stack, and wherein the plurality of neural network branches share the same weights.

11. The device of claim 9, wherein the disparity computation network comprises a three-dimensional convolutional neural network configured to generate three disparity maps based on the generated feature maps.

12. The device of claim 9, wherein the machine learning model is configured to determine the respective depth map of each image set based on the determined two-dimensional offsets between the plurality of images of the image set.

13. The device of claim 9, wherein the machine learning model is configured to determine the optical flow 114, based on the determined two-dimensional offsets between at least one of, the first images of adjacent image sets and the second images of adjacent image sets.

14. The device of claim 1, further comprising:
a plurality of sensors mountable on a vehicle, the plurality of sensors adapted to capture the sequence of image sets,
wherein the plurality of sensors preferably comprises a stereo camera, and wherein preferably each image set comprises a pair of stereo images.

15. A computer-implemented method for localizing a vehicle, the method comprising:
inputting a sequence of image sets to a machine learning model, wherein each image set of the sequence comprises at least a first image and a second image;
determining by the machine learning model, for each image set, a respective depth map based on at least the first image and the second image of the image set, resulting in a sequence of depth maps;
determining by the machine learning model, an optical flow based on at least one of, the first images from the sequence of image sets and the second images of the sequence of image sets; and
localizing the vehicle based on the sequence of depth maps and the optical flow.
